(19) United States
(12) Patent Application Publication
(10) Pub. No.: US 2005/0281483 A1
(43) Pub. Date: Dec. 22, 2005

(54) Tilted angle detection for document image deskew

(75) Inventor: I-Chen Teng, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/145,571

(22) Filed: Jun. 3, 2005

(30) Foreign Application Priority Data
Jun. 8, 2004 (TW) 093116389

(51) Int. Cl. G06K 9/36; G06F 15/00

(52) U.S. Cl. 382/289; 358/1.12

(57) ABSTRACT

The invention relates to a method for detecting a tilted angle when it scans the document. First, the present invention scans the document to produce a first scanned data, and the fist scanned data is transformed into a binary image. The present invention determines whether the binary image comprises a graphic area. If the binary image comprises the graphic area, the present invention deletes the graphic area from the binary image to produce a deleted binary image; moreover, it uses a predetermined way, based on the deleted binary image, to calculate the tilted angle.

### BACKGROUND OF THE INVENTION

1. Field of the Invention

This present invention relates to a method and a device for detecting a tilted angle when it scans a document.

2. Description of the Prior Art

When the users scan or print a document, they sometimes carelessly put the document, so that the document is scanned into an image with a tilted angle. When the quantity of the document increases, users must correct the document in a manual way, page by page, and it is inconvenient.

In the prior art, the tilted angle of the document can be calculated by a software to further correct the document. As the method of the U.S. Pat. No. 6,493,470, it uses a software program to scan the document with the correcting function of the tilted angle.

The present invention mainly provides a method for detecting the tilted angle and for correcting the scanned image when it scans the document.

### SUMMARY OF THE INVENTION

The present invention mainly provides a method for detecting a tilted angle when it scans the document; moreover, it further corrects the scanned image.

In another purpose, the present invention provides a device for automatically detecting the tilted angle when it scans the document; moreover, it further corrects the scanned image.

According to the method for detecting the tilted angle when the present invention scans the document, first, it scans the document to produce a first scanned data; next, the first scanned data is transformed into a gray image, and then the gray image is transformed into a binary image according to the threshold.

The present invention determines whether the binary image comprises a graphic area. If the binary image comprises the graphic area, it deletes the graphic area from the binary image to further produce a deleted binary image. The present invention calculates the tilted angle by a predetermined way according to the deleted binary image, and then it uses a second predetermined resolution to scan the document to further produce a second scanned data; moreover, the present invention rotates the second scanned data according to the calculated tilted angle.

In the method of the present invention for detecting the tilted angle, software programs can be designed to automatically calculate the tilted angle when it scans the document; moreover, it automatically corrects the scanned image. When the method for detecting the tilted angle is applied to scan or print the document, the users don't need to correct the document in a manual way. It is very convenient.

The advantage and spirit of the invention may be understood by the following recitations together with the appended drawings.

### BRIEF DESCRIPTION OF THE APPENDED DRAWINGS

FIG. 1 is a system block diagram of the embodiment of a detecting device of a tilted angle in the present invention.

FIG. 2 is a schematic diagram of the embodiment of a histogram of the transforming module of FIG. 1.

FIG. 3 is a flow chart of the operational method of the threshold of the transforming module of the embodiment of FIG. 1.

FIG. 4 is a schematic diagram of the embodiment of using a mask of the determining module of FIG. 1.

FIG. 5 is a flow chart of the steps of the detected method of the tilted angle of the embodiment in the present invention.

FIG. 6 is a flow chart of the steps of another embodiment for detecting the tilted angle in the present invention.

### DETAILED DESCRIPTION OF THE INVENTION

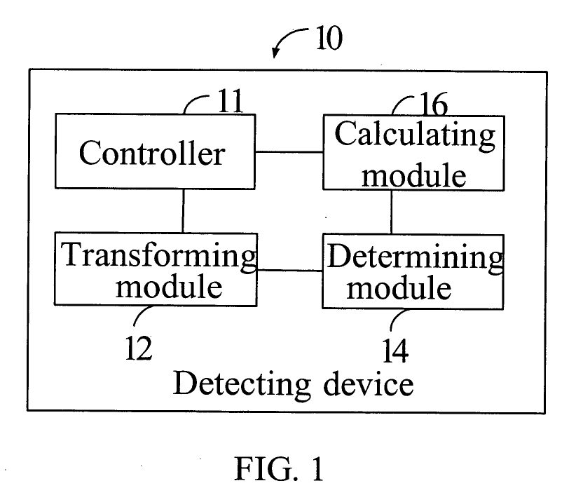

Please refer to FIG. 1. FIG. 1 is a system block diagram of an embodiment of a detecting device 10 of a tilted angle in the present invention. The detecting device 10 of the present invention is used to detect the tilted angle when it scans the document. The detecting device 10 comprises a controller 11, a transforming module 12, a determining module 14, and a calculating module 16.

The controller 11 scans the document by the predetermined resolution to produce the first scanned data. The predetermined resolution must have the purpose of reducing the scanned image for unrecognizable letter of the document. In the embodiment of the invention, the predetermined resolution is about 30 dpi. In another embodiment, the predetermined resolution is the resolution used in previewing the image when it scans the document.

The transforming module 12 transforms the first scanned data into the binary image. The determining module 14 determines whether the binary image comprises a graphic area. If the binary image comprises the graphic area, it deletes the graphic area from the binary image to produce a deleted binary image. The calculating module 16 calculates the tilted angle by a predetermined way according to the deleted binary image.

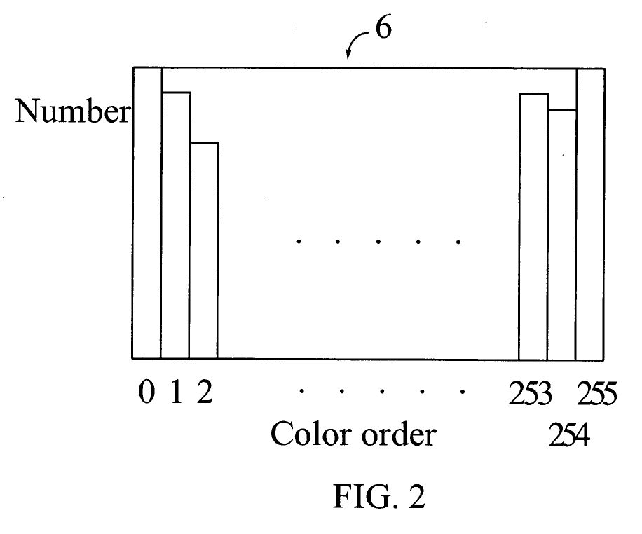

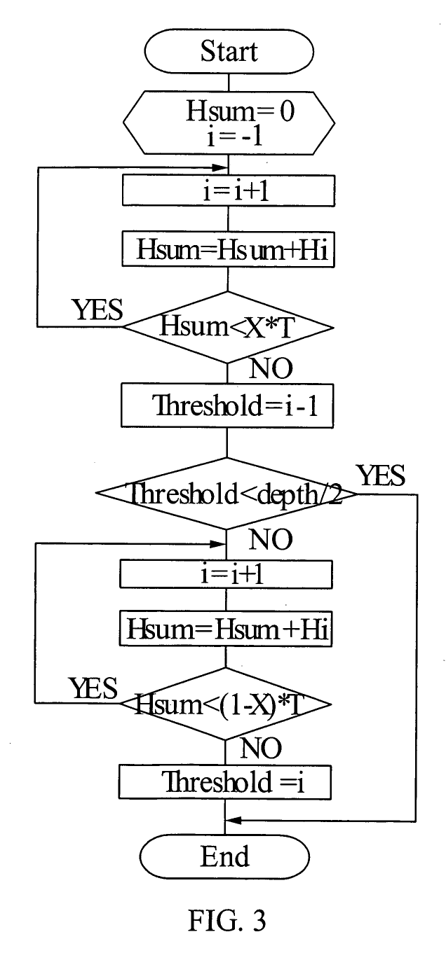

Please refer FIG. 2 and FIG. 3. FIG. 2 is a schematic diagram of a histogram of the transforming module 12 of the embodiment of FIG. 1. FIG. 3 is a flow chart of the operational method of the threshold of the transforming module 12 of the embodiment of FIG. 1. The transforming module 12 transforms a first scanned data into a gray image; moreover, it transforms the gray image into a binary image according to the threshold. An embodiment of the histogram with 256 color orders will be used to explain the way for transforming the gray image into the binary image. In the embodiment of FIG. 2, the gray image is separated into 256 orders, from 0 to 256. Every order comprises a graphics number in that the gray image occupies the graphics number in the order. For example, when the first scanned data is transformed into the gray image, the histogram can be used to get the graphic numbers of every order in the gray image. According to that, the threshold can be set to transform the gray image to the binary image.

The setting of the threshold requires the consideration of the relation between the background and letters. In an embodiment, the situation of the first stage is dark background and light letter, and then the second stage situation is light background and dark letter. The formulas of the threshold are respectively a first formula and a second formula.

$$a first formula ( the first stage ) \text{:} threshold = max \{ n \vert {\sum }_{i = 0}^{n} Hi < X * T \} ;$$

$$\begin{matrix}a second formula ( the second stage ) \text{:} threshold = min \\ \{ n \vert {\sum }_{i = 0}^{n} Hi > ( 1 - X ) * T \} .\end{matrix}$$

In both the first and the second formula, i is an i-th order, and X is, obtained by experimental observations, is the percentage of letters occupying the background; H are the total values of the occupying numbers of every order of the histogram, and then T are all numbers of the graphics element.

In an embodiment, the threshold uses a software system to operate. FIG. 3 is a flow chart of the operational method of the threshold of the embodiment of FIG. 1. The data in the histogram of the gray image enters the operational flow to obtain the value of an order (i.e. the threshold). The histogram of the gray image can be separated into two areas based on the threshold to further transform the gray image into the binary image; moreover, the binary image comprises black and white (i.e. 0 and 1), wherein 0 is black color of the binary image, and 1 is white color of the binary image. The above description is the embodiment of the dynamic calculation of the threshold of the gray image being transformed into the binary image. In the prior art, there are many known ways to select the threshold, so the others will not be explained here.

The determining module 14 is used to determine whether the binary image comprises the graphics area. The determining module 14 determines whether the binary image comprises the graphics area according to a 4-connection judgment method, an 8-connection judgment method, or a mask method. If the binary image comprises the graphic area, the determining module 14 deletes the graphic area in the binary image to produce a deleted binary image. Both the 4-connection judgment method and the 8-connection judgment method are known in the prior art. If connected area is bigger than the predetermined value, the determining module 14 determines to delete the graphics area

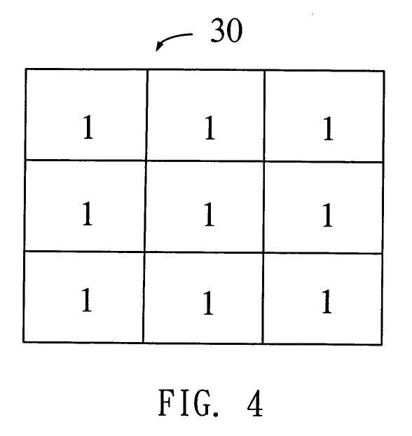

Please refer to FIG. 4. FIG. 4 is a schematic diagram of the embodiment of using the mask of the determining module 14 of FIG. 1. In another embodiment, the determining module 14 uses the mask method to determine whether the binary image comprises the graphics area. The embodiment of FIG. 4 is a 3*3 mask used on the binary image. If the product of the applied mask of the area in the binary image is bigger than a predetermined value (e.g. being bigger than 4), the determining module 14 determines that this area is the graphic area. The complexity of this method is less than that of the 4-connection judgment method or the 8-connection judgment method.

The calculating module 16 calculates the tilted angle by a predetermined way according to the deleted binary image. The predetermined way of the calculating module 16 comprises a step of Hough transform. The Hough transform is as follows:
ρ=x cos θ+y sinθ; 0≦θ<π

In the Hough transform, there are co-linear M points in the (x,y) coordinate plain. The (ρ,θ) coordinate plain corresponds to the M sine curves at the same point. The (x,y) coordinates of collected points in the deleted binary image can be transformed into the collected sine curves of the (ρ,θ) coordinate plain by the Hough transform; moreover, those sine curves, based on the directivity of the letters on the document, mainly crosses many points which approximate to the θ value. The Hough transform calculates the average or proportion based on those values of collected points to obtain the approximate tilted angle (θ) on the document.

The controller 11 can also scan the document by a second predetermined resolution to produce a second scanned data, wherein the second predetermined resolution is the normal resolution of general scanned document, and it can scan the data of the document completely; moreover, a first predetermined resolution is less than the second predetermined resolution. The controller 11, based on the calculated tilted angle of the document, rotates the second scan data and corrects the document.

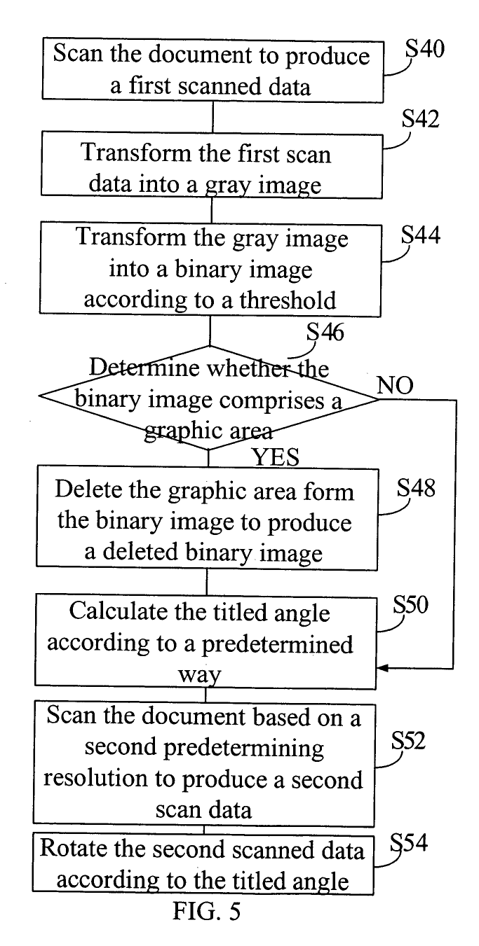

Please refer to FIG. 5. FIG. 5 is a flow chart of the steps of the detecting method of the tilted angle of the embodiment in the present invention. The present invention provides the method for producing the tilted angle when it scans the document. The flow of scanning a document by detecting the tilted angle in the invention comprises the following steps:

S40: Scan the document to produce a first scanned data;

S42: Transform the first scan data into a gray image;

S44: Transform the gray image into a binary image according to a threshold.

S46: Determine whether the binary image comprises a graphic area. If the binary image comprises the graphic area, the present invention performs step S48, or else it jumps to step S50;

S48: Delete the graphic area in the binary image to produce a deleted binary image;

S50: Calculate the tilted angle by a predetermined way;

S52: Scan the document based on a second predetermining resolution to produce a second scanned data;

S54: Rotate the second scanned data according to the tilted angle;

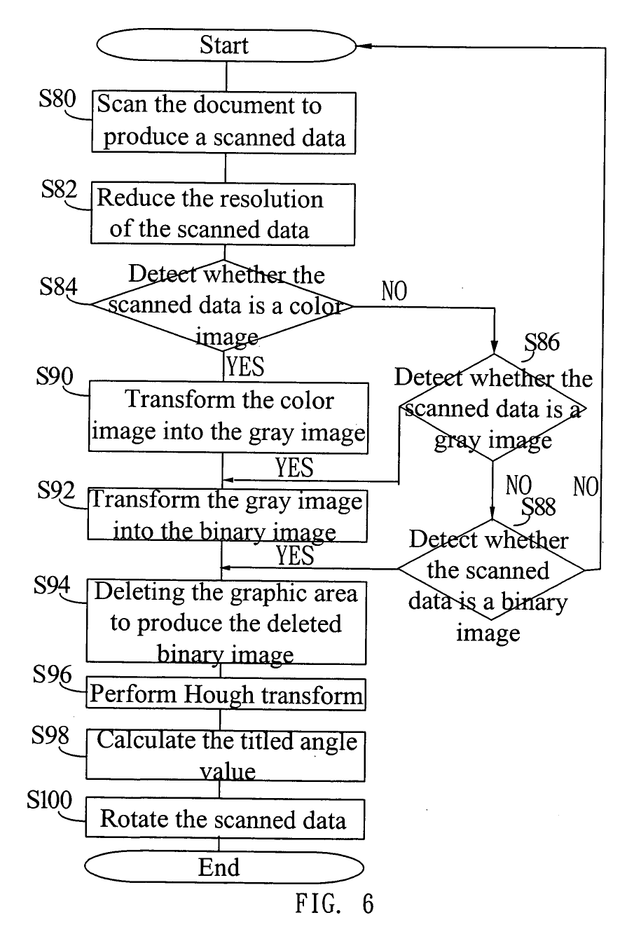

Please refer to FIG. 6. FIG. 6 is a flow chart of the steps of another embodiment for detecting the tilted angle in the present invention. In another embodiment, the present invention for detecting the tilted angle when it scans the document comprises the following steps:

S80: Scan the document to produce a scanned data;

S82: Reduce the resolution of the scanned data;

S84: Detect whether the scanned data is a color image. If the scanned data is a color image, the present invention jumps to step S90, or else it performs step S86;

S86: Detect whether the scanned data is a gray image. If the scanned data is a gray image, the present invention jumps to step S92, or else it performs step S88;

S88: Detect whether the scanned data is a binary image. If the scanned data is a binary image, the present invention jumps to step S94, or else it restarts step S80.

S90: Transform the color image into the gray image;

S92: Transform the gray image into the binary image;

S94: Delete the graphic area in the binary image to produce the deleted binary image;

S96: Perform the Hough transform;

S98: Calculate the tilted angle value;

S100: Rotate the scanned data;

In the embodiment of FIG. 6, the present invention does not need to scan the document twice, and it just needs to reduce the resolution of the scanned data. Then, the present invention calculates the tilted angle to correct the document; therefore, it can economize time and labor.

The method or the device for detecting the tilted angle in the invention can use software to automatically calculate the tilted angle when it scans the document, and it automatically corrects the scanned image of the document. Therefore, when the method or the device for detecting the tilted angle is used to scan or print the document in the present invention, the users do not need to correct the scan/print document in a manual way, page by page, and it can economize time and labor.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method for detecting a tilted angle when scanning a document, wherein the method comprises:
(a) scanning the document to produce a first scanned data;
(b) transforming the first scanned data into a binary image;
(c) determining whether the binary image comprises a graphics area, and deleting the graphics area from the binary image to produce a deleted binary image if the binary image comprises the graphics area; and
(d) using a predetermined way to calculate the tilted angle according to the deleted binary image.

2. The method of claim 1, wherein the method further comprises:
(e) scanning the document based on a second predetermined resolution to produce a second scanned data; and
(f) rotating the second scanned data according to the tilted angle.

3. The method of claim 2, wherein the first scanned data is scanned according to a first predetermined resolution in step (a), and the first predetermined resolution is less than the second predetermined resolution.

4. The method of claim 1, wherein step (b) comprises:
(b1) transforming the first scanned data into a gray image; and
(b2) transforming the gray image into the binary image.

5. The method of claim 4, wherein the gray image is transformed into the binary image according to a threshold in step (b2).

6. The method of claim 1, wherein a 4-connection judgment method is used to determine whether the binary image comprises the graphics area in step (c).

7. The method of claim 1, wherein an 8-connection judgment method is used to determine whether the binary image comprises the graphics area in step (c).

8. The method of claim 1, wherein a mask judgment method is used to determine whether the binary image comprises the graphics area in step (c).

9. The method of claim 1, wherein the predetermined way in step (d) comprises a Hough transform.

10. The method of claim 1, wherein the method further comprises:
(g) rotating the first scanned data according to the tilted angle.

11. The method of claim 10, wherein step (b) comprises:
(b I) reducing the resolution of the first scanned data to produce the first low resolution data;
(b II) transforming the first low resolution data into a gray image; and
(b III) transforming the gray image into the binary image.

12. A device for detecting a tilted angle when scanning a document, wherein the device comprises:
a controller scanning the document to produce a first scanned data;
a transforming module transforming the first scanned data into a binary image;
a determining module determining whether the binary image comprises a graphics area and deleting the binary image from the graphics area to produce a deleted binary image if the binary image comprises the graphics area; and
a calculating module using a predetermined way to calculate the tilted angle according to the deleted binary image.

13. The device of claim 12, wherein the controller further scans the document based on a second predetermined resolution to produce the second scanned data, and the controller rotates the second scanned data according to the tilted angle.

14. The device of claim 13, wherein the controller scans the document to produce the first scanned data based on a first predetermined resolution, and the first predetermined resolution is less than the second predetermined resolution.

15. The device of claim 12, wherein the transforming module transforms the first scanned data into a gray image, and then transforms the gray image into the binary image.

16. The device of claim 15, wherein the transforming module transforms the gray image into the binary image according to a threshold value.

17. The device of claim 12, wherein the detecting module uses a 4-connection judgment method to determine whether the binary image comprises the graphics area.

18. The device of claim 12, wherein the detecting module uses an 8-connection judgment method to determine whether the binary image comprises the graphics area.

19. The device of claim 12, wherein the detecting module uses a mask judgment method to determine whether the binary image comprises the graphics area.

20. The device of claim 12, wherein the predetermined way comprises a Hough transform.

21. The device of claim 12, wherein the transforming module reduces the resolution of the first scanned data to produce the first low resolution data, transforms the first low resolution data into the gray image, and transforms the gray image into the binary image.
